(19) United States
(12) Patent Application Publication
(10) Pub. No.: US 2010/0183060 A1
(43) Pub. Date: Jul. 22, 2010

(54) METHOD AND APPARATUS OF FREQUENCY OFFSET-FREE FRAME SYNCHRONIZATION FOR HIGH ORDER QAM SIGNALS IN MODEM APPARATUS

(75) Inventors: Eung Don Lee, Daejeon (KR); Sung Hoon Kim, Daejeon (KR); Jin Soo Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/643,295

(22) Filed: Dec. 21, 2009

(30) Foreign Application Priority Data
Jan. 19, 2009 (KR) 10-2009-0004049
May 19, 2009 (KR) 10-2009-0043520

(51) Int. Cl. H04B 1/38; H04L 27/06

(52) U.S. Cl. 375/222; 375/343

(57) ABSTRACT

Provided is a method and apparatus for performing a frequency offset-free frame synchronization with respect to high order quadrature amplitude modulation (QAM) symbols in a modem apparatus. A method of performing a correlation-based frame synchronization using magnitudes of QAM symbols in a modem apparatus, may include: constructing a synchronization pattern using the magnitudes of the QAM symbols; sequentially calculating a magnitude of each of received signals based on a symbol unit to construct a received vector; and obtaining a frame synchronization based on a correlation between the received vector and the synchronization pattern.

### CROSS-REFERENCE TO RELATED APPLICATIONS

This application claims the benefit of Korean Patent Application No. 10-2009-0004049, filed on Jan. 19, 2009, and Korean Patent Application No. 10-2009-0043520, filed on May 19, 2009, in the Korean Intellectual Property Office, the disclosures of which are incorporated herein by reference.

### BACKGROUND

1. Field of the Invention

Embodiments of the present invention relate to a method of obtaining, by a modem apparatus, a robust characteristic against a frequency offset of a frame synchronization that is one of synchronization technologies of a higher order quadrature amplitude modulation (QAM), and a method of decreasing a hardware complexity.

2. Description of the Related Art

Generally, in a digital communication, a bitstream includes a frame in a form of a block or a packet. A process of finding a frame boundary position is referred to as a frame synchronization. In the case of a cable downstream, since quadrature amplitude magnitude (QAM) symbols are consecutively transmitted, the cable downstream may not have a frame structure. However, as a QAM order becomes higher, a demodulation using a blind scheme may become more complex. Therefore, the demodulation may become facilitated by inserting a preamble for a transmission in the frame structure. A synchronization pattern may be used for a frame synchronization. In the case of a packet transmission, the synchronization pattern may be inserted into each packet. In the case of a consecutive transmission as in the cable downstream, the synchronization pattern may be periodically inserted.

FIG. 1 illustrates an existing correlation-based frame synchronization structure according to a conventional art. Referring to FIG. 1, the correlation-based frame synchronization structure includes a delay line 110, a complex inner product operator 120, and an accumulator 130.

Generally, a receiver may recover symbol timing and then perform a frame synchronization prior to recovery a carrier. Therefore, in the case of an existing maximum likelihood (ML) scheme or a correlation scheme of FIG. 1, when a carrier frequency offset slightly increases, a frame error probability may significantly increase.

To solve the above problem, Zae Yong Choi and Yong H. Lee proposed a simplified method of deriving the ML scheme based on the carrier frequency offset and enhancing the complex structure, and a combined method using both the simplified method and the existing correlation scheme.

FIG. 2 illustrates a double correlation-based frame synchronization structure proposed by Zae Yong Choi and Yong H. Lee according to the conventional art. Referring to FIG. 2, the double correlation-based frame synchronization structure includes a delay line 210, a complex number multiplier 220, an accumulator 230, and a square root operator 240.

The method of FIG. 2 proposed by Zae Yong Choi and Yong H. Lee is based on the double correlation. Accordingly, in comparison to the existing correlation-based frame synchronization scheme, there is a need to perform two times a complex number multiplication operation, and thus the frame synchronization structure is basically complex.

### SUMMARY

An aspect of the present invention provides a method and apparatus for performing a frequency offset-free frame synchronization with respect to high order quadrature amplitude modulation (QAM) symbols in a modem apparatus.

Another aspect of the present invention also provides a method and apparatus for performing a frame synchronization using magnitudes of QAM symbols in a modem apparatus to obtain a robust performance against a frequency offset, and a method and apparatus for decreasing a hardware complexity by converting received signals and synchronization pattern signals to calculate correlation values when performing the frame synchronization.

Another aspect of the present invention also provides a method and apparatus for performing a frame synchronization using magnitudes of QAM symbols, instead of using an existing double correlation-based frame synchronization apparatus, to obtain a robust performance against a frequency offset in a high order QAM system, and a method and apparatus for decreasing a hardware complexity by converting QAM symbols to binary signals to calculate correlations when performing the frame synchronization.

According to an aspect of the present invention, there is provided a method of performing a correlation-based frame synchronization using magnitudes of QAM symbols in a modem apparatus, the method including: constructing a synchronization pattern using the magnitudes of the QAM symbols; sequentially calculating a magnitude of each of received signals based on a symbol unit to construct a received vector; and obtaining a frame synchronization based on a correlation between the received vector and the synchronization pattern.

According to another aspect of the present invention, there is provided a method of performing a binary correlation-based frame synchronization using a signal conversion in a modem apparatus, the method including: constructing a binary synchronization pattern that is expressed by a binary signal using magnitudes of QAM symbols; sequentially converting each of received signals to the binary signal based on a symbol unit to construct a binary received vector; and obtaining a frame synchronization based on a correlation between the binary synchronization pattern and the binary received vector.

According to still another aspect of the present invention, there is provided an apparatus for performing a correlation-based frame synchronization using magnitudes of QAM symbols in a modem apparatus, the apparatus including: a synchronization pattern construction unit to construct a synchronization pattern using the magnitude of the QAM symbol; a received vector construction unit to sequentially calculate a magnitude of each of received signals based on a symbol unit to construct a received vector, and to construct a received vector that includes the calculated magnitudes of the received signals; and a synchronization obtainment unit to obtain a frame synchronization based on a correlation between the received vector and the synchronization pattern.

According to yet another aspect of the present invention, there is provided an apparatus for performing a binary correlation-based frame synchronization using a signal conversion in a modem apparatus, the apparatus including: a synchronization pattern construction unit to construct a binary synchronization pattern that is expressed by a binary signal using magnitudes of QAM symbols; a received signal construction unit to sequentially calculate power values of received signals based on a symbol unit, to convert the power values of the received signals to the binary signals based on a predetermined power threshold, and to construct a binary received signal; and a synchronization obtainment unit to obtain a frame synchronization based on a correlation between the binary received vector and the binary synchronization pattern.

### EFFECT

According to embodiments of the present invention, there may be provided a correlation-based frame synchronization method using magnitudes of quadrature amplitude modulation (QAM) symbols, and a binary correlation-based frame synchronization method using a signal conversion in a modem apparatus. Since the magnitudes of the QAM symbols are used, an excellent frame synchronization performance may be obtained regardless of a carrier frequency offset and a calculation amount may significantly decrease. In particular, even in a noisy environment, the binary-correlation-based frame synchronization method may have an excellent performance and may also significantly decrease a calculation amount.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an existing correlation-based frame synchronization structure according to a conventional art;

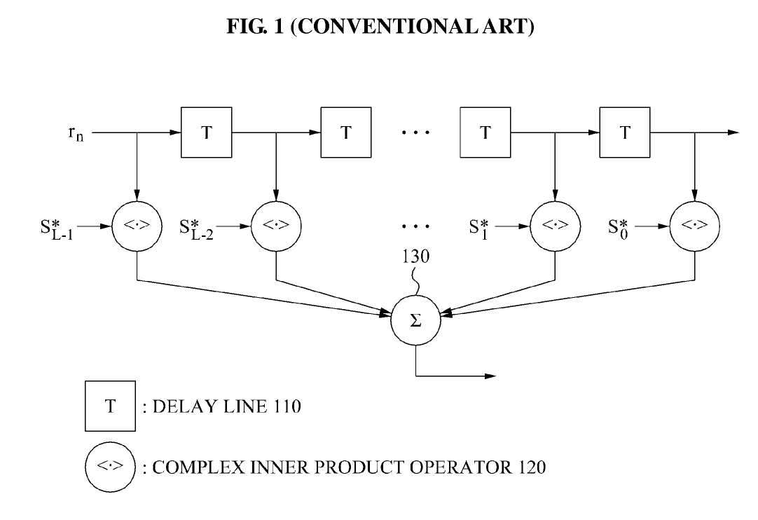

FIG. 2 illustrates a double correlation-based frame synchronization structure proposed by Zae Yong Choi and Yong H. Lee according to the conventional art;

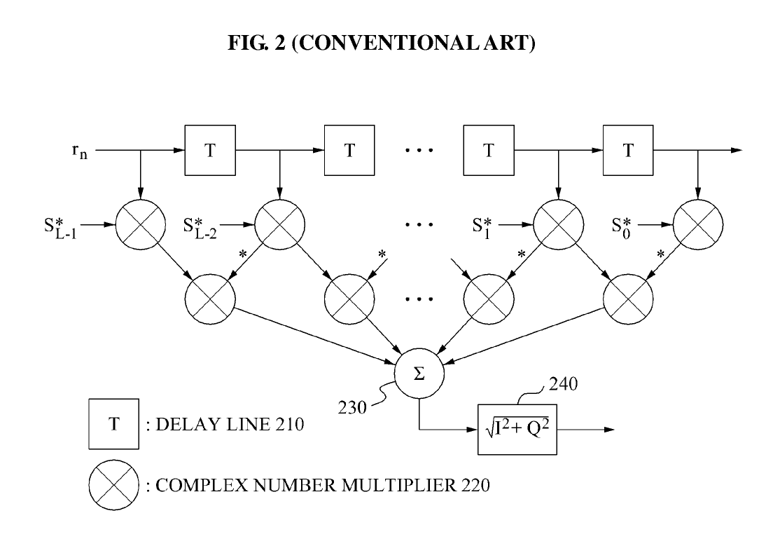

FIG. 3 illustrates a correlation-based frame synchronization structure using magnitudes of quadrature amplitude modulation (QAM) symbols in a modem apparatus according to an embodiment of the present invention;

FIG. 4 illustrates a binary correlation-based frame synchronization structure using a signal conversion in a modem apparatus according to an embodiment of the present invention;

FIG. 5 is a graph illustrating a power threshold that is a reference to convert a received signal to a binary signal for a binary correlation-based frame synchronization according to an embodiment of the present invention;

FIG. 6 is a flowchart illustrating a method of performing a correlation-based frame synchronization using magnitudes of QAM symbols in a modem apparatus according to an embodiment of the present invention; and

FIG. 7 is a flowchart illustrating a method of performing a binary correlation-based frame synchronization using a signal conversion in a modem apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a known function or configuration they may render the purpose of the present invention unnecessarily ambiguous in describing the present invention, the detailed description will be omitted herein.

Embodiments of the present invention disclose a method and apparatus for performing a frame synchronization using magnitudes of QAM symbols in a modem apparatus to obtain a robust performance against a frequency offset, and a method and apparatus for decreasing a hardware complexity by converting received signals and synchronization pattern signals to calculate correlation values when performing the frame synchronization.

Prior to description, it is considered that frames in the following structure are consecutively transmitted in an M-ary QAM system having an additive white Gaussian noise (AWGN) channel.

Each frame may include N M-ary QAM symbols. First L symbols form a frame synchronization pattern s=(s₀, s₁, . . . s_{L-1}), and the remaining N-L symbols are random data symbol streams d=(d_{L}, d_{L+1}, . . . d_{N-1}). A data symbol may be selected equally likely from an M-ary signal constellation {Wⱼ|1≦j≦M}.

A received baseband signal may be represented by the following Equation 1:

r(n)=a(n)e^{j(2πf}^{_{c}}^{nT+φ}^{₀}⁾+w(n) [Equation 1]

n=kN+i (k denotes an integer, 0≦i≦N−1),

where a(n) denotes an n-th transmission symbol a_{I}(n)+ja_{Q}(n), f_{c} denotes a subcarrier frequency offset, φ₀ denotes a carrier phase offset, and w(n) denotes two-dimensional AWGN with variance N₀/2+jN₀/2 and zero mean with respect to the n-th transmission symbol. Here, it is assumed that AWGN are mutually independent.

According to an embodiment of the present invention, a synchronization pattern may be initially generated as follows.

A binary marker of Maurey and Styles of which a length is 16, and a binary synchronization pattern Ŝ may be expressed by the following Equation 2:

L=16 binary marker stream: 165620₈=1110101110010000₂

Ŝ={+1, +1, +1, −1, +1, −1, +1, +1, +1, −1, −1, +1, −1, −1, −1, −1}. [Equation 2]

In a M-ary QAM system, when Ŝ\hat{Sᵢ}=+1, a symbol (\sqrt{M}−1, \sqrt{M}−1) may be generated. When Sᵢ=−1, a symbol (1, 1) may be generated. A synchronization pattern s having different magnitudes of QAM symbols may be expressed by the following Equation 3:

s={(\sqrt{M}−1, \sqrt{M}−1), (\sqrt{M}−1, \sqrt{M}−1), (\sqrt{M}−1, \sqrt{M}−1), (1,1), (\sqrt{M}−1, \sqrt{M}−1), (1,1), (\sqrt{M}−1, \sqrt{M}−1), (\sqrt{M}−1, \sqrt{M}−1), (\sqrt{M}−1, \sqrt{M}−1), (1,1), (1,1), (\sqrt{M}−1, \sqrt{M}−1), (1,1), (1,1), (1,1), (1,1)}. [Equation 3]

The correlation-based frame synchronization method using the magnitudes of the QAM symbols may determine an estimate \hat{μ}(0≦\hat{μ}≦N−1) where (|r_{\hat{μ}}|, |r_{\hat{μ}+1}|, . . . , |r_{\hat{μ}+L-1}|) obtained from N received signals may maximize a correlation corresponding to (|s₀|, |s₁|, . . . , |s_{L-1}|), which may be given by the following Equation 4:

$$\hat{μ} = {max}_{1 \leq μ \leq N - 1} {\sum }_{i = 0}^{L - 1} \vert {r}_{i + μ} \vert \vert {s}_{i} \vert . \qquad [ Equation 4 ]$$

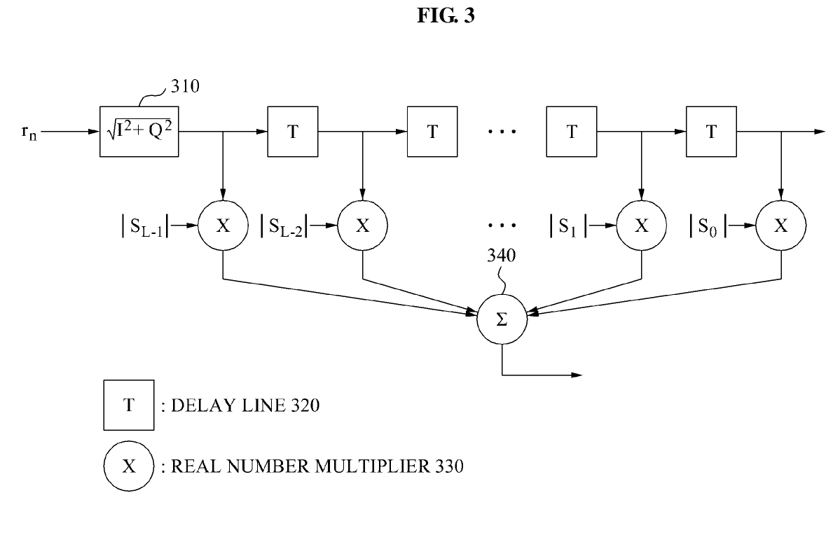

According to an embodiment of the present invention, the frame synchronization method may generally use the magnitudes of the QAM symbols to avoid the effect from the frequency offset. As shown in the above Equation 4, the frame synchronization method may be expressed by the square root operation \sqrt{I²+Q²} and L real number multiplication operations. Therefore, in comparison to a double correlation method proposed by Zae Yong Choi and Yong H. Lee, a number of times that the real number multiplication operation is performed may be reduced to about ⅛. When the above Equation 4 is expressed in a frame synchronization structure, it may be expressed as shown in FIG. 3.

FIG. 3 illustrates a correlation-based frame synchronization structure using magnitudes of QAM symbols in a modem apparatus according to an embodiment of the present invention.

A correlation-based frame synchronization apparatus using the magnitudes of the QAM symbols may include a synchronization pattern construction unit (not shown), a received vector construction unit, and a synchronization obtainment unit.

The synchronization pattern construction unit may set a synchronization pattern using the magnitudes of the QAM symbols.

The received vector construction unit may include a squared root operator 310 and a delay line 320. When a signal is received, the received vector construction unit may calculate a magnitude of the received signal based on a symbol unit using the square root operator 310. Also, the received vector construction unit may delay the magnitude of the received signal using L delay lines 320 to output a received vector including the magnitude of the received signal. Here, L denotes a length of the synchronization pattern.

The synchronization obtainment unit may include a correlation operator and a correlation comparator (not shown). The correlation operator may include L real number multipliers 330 and an accumulator 340. Here, L denotes the length of the synchronization pattern.

The correlation operator may obtain correlation values by performing a calculation operation using the real number multiplier 330 and the accumulator 340. The real number multiplier 330 may perform a real number multiplication operation for a magnitude of each of received signals included in the received vector, and a magnitude of each of synchronization signals included in the synchronization pattern. The accumulator 340 may sum up all the real number multiplication values.

The correlation comparator may determine, as a frame starting position, a received signal corresponding to the estimate \hat{μ} that is a greatest correlation value among the correlation values.

To further decrease a calculation amount of the correlation-based frame synchronization method using the magnitudes of the QAM symbols, it is possible to replace a complex or real number multiplication operation with an exclusive NOR (X-NOR) operation by converting the received signals to binary signals and applying the binary signals to an existing correlation scheme.

The received signals may be converted to the binary signals to perform a binary correlation scheme using a signal conversion.

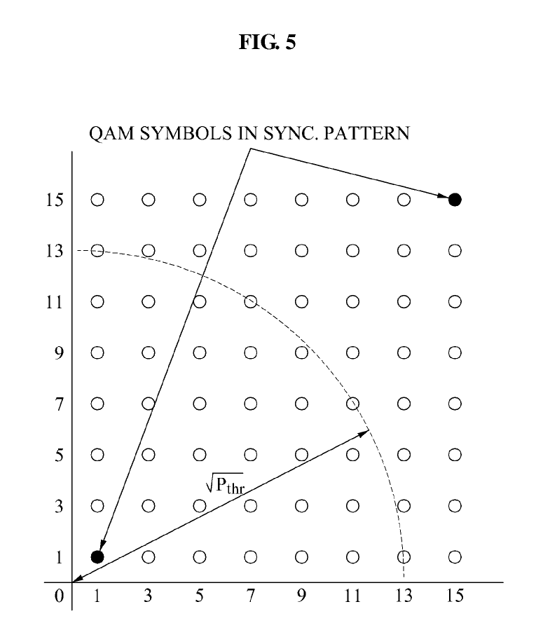

Generally, the QAM symbols may be uniformly distributed. Therefore, as shown in FIG. 5, a boundary Pₜₕᵣ of a QAM symbol power may be determined so that a probability of generating a QAM symbol with a relatively greater magnitude and a probability of generating a QAM symbol with a relatively smaller magnitude may become ½. Based on the boundary Pₜₕᵣ, a received signal rᵢ may be converted to a binary received signal \hat{r}ᵢ according to a received signal power r̅ᵢ, as given by the following Equation 5.

FIG. 5 is a graph illustrating a power threshold that is a reference to convert a received signal to a binary signal for a binary correlation-based frame synchronization according to an embodiment of the present invention.

The binary received signal \hat{r}ᵢ may be expressed by the following Equation 5:

$${\hat{r}}_{i} = \{ \begin{matrix}+ 1 & {\overline{r}}_{i} \geq {P}_{rhr} \\ - 1 & {\overline{r}}_{i} < {P}_{rhr} .\end{matrix} \qquad [ Equation 5 ]$$

When a likelihood function L_{T}(μ) is defined using a correlation between a binary received vector \hat{r}, converted from a received vector r, and a binary synchronization pattern Ŝ, a complex or real number multiplication operation may be replaced with an X-NOR operation, whereby a frame synchronization may be more readily performed.

The binary correlation-based frame synchronization method using the signal conversion may determine an estimate \hat{μ}(0≦\hat{μ}≦N−1) where a binary received vector (\hat{r}_{\hat{μ}}, \hat{r}_{\hat{μ}+1}, . . . , \hat{r}_{\hat{μ}+L-1}) obtained from N received signals may maximize a correlation corresponding to a binary synchronization pattern (ŝ₀, ŝ₁, . . . , ŝ_{L-1}), which may be given by the following Equation 6:

$$\hat{μ} = {max}_{1 \leq μ \leq N - 1} {\sum }_{i = 0}^{L - 1} {\hat{r}}_{i + μ} ⊗ {\hat{s}}_{i} . \qquad [ Equation 6 ]$$

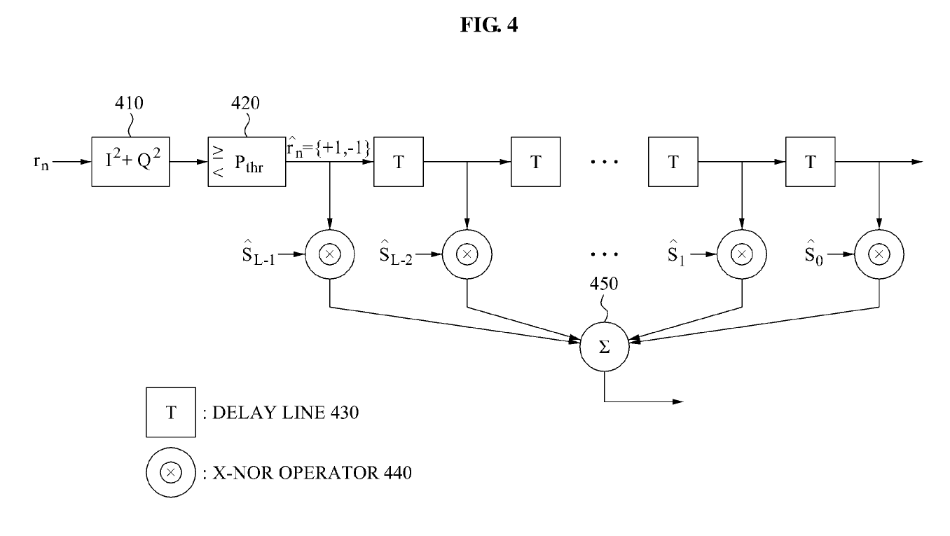

When the above Equation 6 is expressed in the frame synchronization structure, it may be performed as shown in FIG. 4.

FIG. 4 illustrates a binary correlation-based frame synchronization structure using a signal conversion in a modem apparatus according to an embodiment of the present invention.

A binary correlation-based frame synchronization apparatus using the signal conversion may include a synchronization pattern construction unit (not shown), a received vector construction unit, and a synchronization obtainment unit.

The synchronization pattern construction unit may set a binary synchronization pattern that is expressed as a binary signal using a magnitude of a QAM symbol

The received vector construction unit may include a power operator 410, a power comparison-based binary converter 420, and a delay line 430. When a signal is received, the received vector construction unit may calculate a power of the received signal using the power operator 410. Also, the received vector construction unit may convert the power of the received signal to the binary signal based on a predetermined power threshold using the power comparison-based binary comparator 420. The received vector construction unit may output a binary received vector that includes binary received signals using the L delay lines to delay the binary received signals.

The synchronization obtainment unit may include a correlation operator and a correlation comparator. The correlation operator may include a plurality of X-NOR operators 440 and an accumulator 450.

The correlation operator may obtain correlation values by performing a correlation operation using the X-NOR operators 440 and the accumulator 450. The X-NOR operators 450 may sequentially perform an X-NOR operation for binary received signals included in the binary received vector and binary synchronization signals included in the binary synchronization pattern. The accumulator 450 may sum up all the X-NOR values.

The correlation comparator may determine, as a frame starting position, a received signal corresponding to the estimate \hat{μ} that is a greatest correlation value among the correlation values.

Hereinafter, a method of performing a frequency offset-free frame synchronization with respect to high order QAM symbols in a modem apparatus constructed as above according to an embodiment of the present invention will be described.

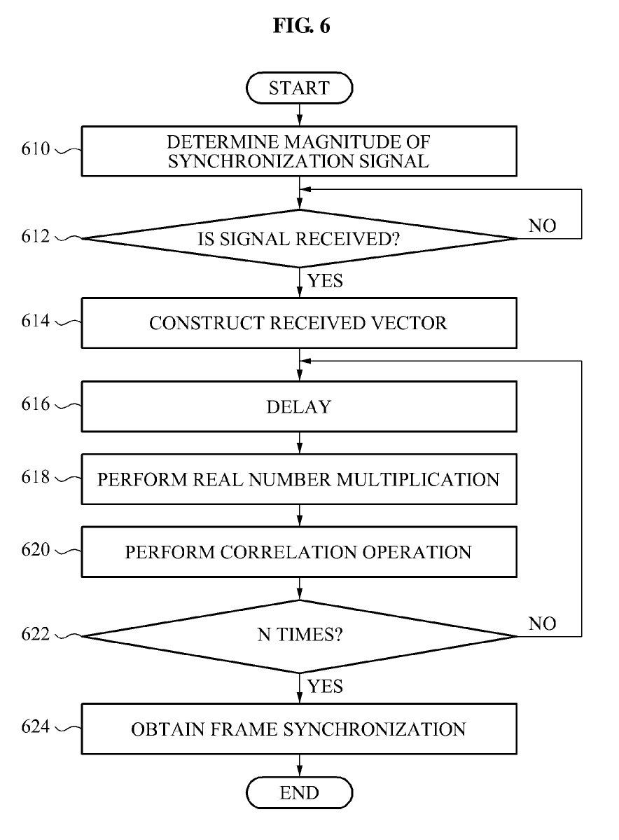

FIG. 6 is a flowchart illustrating a method of performing a correlation-based frame synchronization using magnitudes of QAM symbols in a modem apparatus according to an embodiment of the present invention. Referring to FIG. 6, in operation 610, the modem apparatus may determine a magnitude of each of synchronization signals included in a synchronization pattern.

When a signal is received in operation 612, the modem apparatus may calculate a magnitude of each of N received signals based on a symbol unit and thereby generate a received vector in operation 614.

In operation 616, the modem apparatus may delay the received signals included in the received vector by each single symbol.

In operation 618, the modem apparatus may sequentially perform a real number multiplication operation for square-root operated received signals and synchronization signals.

In operation 620, the modem apparatus may perform a correlation operation for L real number multiplication values. Here, the correlation operation for the L real number multiplication results corresponds to an operation of summing up L real number multiplication values with respect to the L received signals and synchronization signals where the square root operation is performed.

In operation 622, the modem apparatus may verify whether the correlation operation is performed N times.

When the correlation operation is not performed N times in operation 622, the modem apparatus may return to operation 616 and then repeat all the process until the correlation operation is performed N times.

Conversely, when the correlation operation is performed N times in operation 622, the modem apparatus may obtain a frame synchronization by determining, as a frame starting position, a received signal corresponding to a greatest correlation value among correlation values.

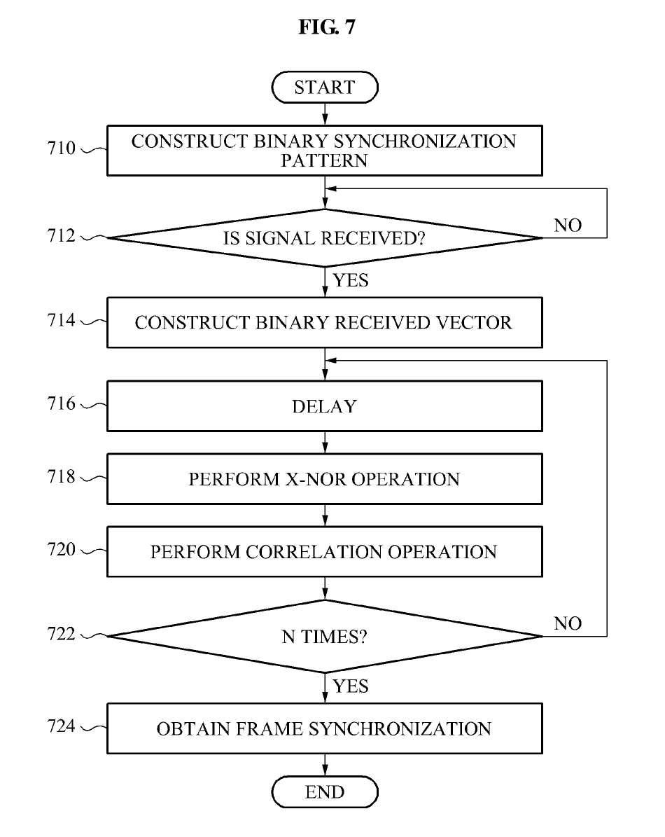

FIG. 7 is a flowchart illustrating a method of performing a binary correlation-based frame synchronization using a signal conversion in a modem apparatus according to an embodiment of the present invention. Referring to FIG. 7, in operation 710, the modem apparatus may convert, to binary signals, synchronization signals included in a synchronization pattern, and thereby construct a binary synchronization pattern.

When a signal is received in operation 712, the modem apparatus may sequentially calculate power values of N received signals based on a symbol unit and convert the received signals to the binary signal by setting the calculated power values as a predetermined power threshold, and thereby construct a binary received vector in operation 714.

In operation 716, the modem apparatus may delay the binary received signals included in the binary received vector by each single symbol.

In operation 718, the modem apparatus may sequentially perform an X-NOR operation for the binary received signals and binary synchronization signals.

In operation 720, the modem apparatus may perform a correlation operation with respect to L X-NOR operation values. Here, the correlation operation for the L X-NOR operation values corresponds to an operation of summing up X-NOR operation values with respect to the L binary received signals and binary synchronization signals.

In operation 722, the modem apparatus may verify whether the correlation operation is performed N times.

When the correlation operation is not performed N times in operation 722, the modem apparatus may return to operation 716 and then repeat all the process until the correlation operation is performed N times.

Conversely, when the correlation operation is performed N times in operation 722, the modem apparatus may obtain a frame synchronization by determining, as a frame starting position, a received signal corresponding to a greatest correlation value among correlation values.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of performing a correlation-based frame synchronization using magnitudes of quadrature amplitude modulation (QAM) symbols in a modem apparatus, the method comprising:
constructing a synchronization pattern using the magnitudes of the QAM symbols;
sequentially calculating a magnitude of each of received signals based on a symbol unit to construct a received vector; and
obtaining a frame synchronization based on a correlation between the received vector and the synchronization pattern.

2. The method of claim 1, wherein the obtaining comprises:
obtaining correlation values by performing a correlation operation between the received vector and the synchronization pattern every time a signal is received; and
obtaining the frame synchronization by determining, as a frame starting position, a received signal corresponding to a greatest correlation value among the correlation values.

3. The method of claim 2, wherein the received vector is constructed by performing a square root operation for each of the received signals included in the received vector.

4. The method of claim 2, wherein the synchronization pattern is constructed by performing a square root operation for each of synchronization signals included in the synchronization pattern.

5. The method of claim 2, wherein the correlation operation sequentially performs a real number multiplication operation for a magnitude of each of the received signals included in the received vector, and a magnitude of each of synchronization signals included in the synchronization pattern, and sums up all the real number multiplication values.

6. A method of performing a binary correlation-based frame synchronization using a signal conversion in a modem apparatus, the method comprising:
constructing a binary synchronization pattern that is expressed by a binary signal using magnitudes of QAM symbols;
sequentially converting each of received signals to the binary signal based on a symbol unit to construct a binary received vector; and
obtaining a frame synchronization based on a correlation between the binary synchronization pattern and the binary received vector.

7. The method of claim 6, wherein the obtaining comprises:
obtaining correlation values by performing a correlation operation between the binary received pattern and the binary synchronization pattern every time a signal is received; and
obtaining the frame synchronization by determining, as a frame starting position, a received signal corresponding to a greatest correlation value among the correlation values.

8. The method of claim 6, wherein the binary received vector is constructed by converting each of received signals included in the binary received vector to the binary signal based on a predetermined power threshold.

9. The method of claim 6, wherein the correlation operation sequentially performs an exclusive NOR operation for binary received signals included in the binary received vector and binary synchronization signals included in the binary synchronization pattern, and sums up all the exclusive NOR values.

10. An apparatus for performing a correlation-based frame synchronization using magnitudes of QAM symbols in a modem apparatus, the apparatus comprising:
a synchronization pattern construction unit to construct a synchronization pattern using the magnitude of the QAM symbol;
a received vector construction unit to sequentially calculate a magnitude of each of received signals based on a symbol unit to construct a received vector, and to construct a received vector that includes the calculated magnitudes of the received signals; and
a synchronization obtainment unit to obtain a frame synchronization based on a correlation between the received vector and the synchronization pattern.

11. The apparatus of claim 10, wherein the received vector construction unit comprises:
a square root operator to calculate the magnitude of each of the received signals; and
L delay lines to delay the magnitudes of the received signals, and
the received vector construction unit constructs the received vector that includes magnitudes of L received signals, and L denotes a length of the synchronization pattern.

12. The apparatus of claim 10, wherein the synchronization obtainment unit comprises:
a correlation operator to obtain correlation values by performing a correlation operation between the received vector and the synchronization pattern every time a signal is received; and
a correlation comparator to obtain the frame synchronization by determining, as a frame starting position, a received signal corresponding to a greatest correlation value among the correlation values.

13. The apparatus of claim 12, wherein the correlation operator comprises:
a real number multiplier to perform a real number multiplication operation for a magnitude of each of the received signals included in the received vector, and a magnitude of each of synchronization signals included in the synchronization pattern; and
an accumulator to sum up all the real number multiplication values.

14. An apparatus for performing a binary correlation-based frame synchronization using a signal conversion in a modem apparatus, the apparatus comprising:
a synchronization pattern construction unit to construct a binary synchronization pattern that is expressed by a binary signal using magnitudes of QAM symbols;
a received signal construction unit to sequentially calculate power values of received signals based on a symbol unit, to convert the power values of the received signals to the binary signals based on a predetermined power threshold, and to construct a binary received signal; and
a synchronization obtainment unit to obtain a frame synchronization based on a correlation between the binary received vector and the binary synchronization pattern.

15. The apparatus of claim 14, wherein the received vector construction unit comprises:
a power operator to calculate the power value of each of the signals;
a power comparison-based binary converter to convert the magnitude of each of the signals to the binary signal based on a predetermined power threshold, and to obtain the binary received vector; and
L delay lines to delay the binary received signals, and
the received vector construction unit constructs the binary received vector that includes L binary received signals, and L denotes a length of the synchronization pattern.

16. The apparatus of claim 14, wherein the synchronization obtainment unit comprises:
a correlation operator to obtain correlation values by performing a correlation operation between the binary received vector and the binary synchronization pattern every time a signal is received; and
a correlation comparator to obtain the frame synchronization by determining, as a frame starting position, a received signal corresponding to a greatest correlation value among the correlation values.

17. The apparatus of claim 16, wherein the correlation operator comprises:
an exclusive NOR operator to sequentially perform an exclusive NOR operation for binary received signals included in the binary received vector and binary synchronization signals included in the binary synchronization pattern; and
an accumulator to sum up the exclusive NOR values.
